(19) United States
(12) Patent Application Publication
(10) Pub. No.: US 2009/0122150 A1
(43) Pub. Date: May 14, 2009

(54) Imaging system with improved image quality and associated methods

(76) Inventors: Gal Shabtay, Tel-Aviv (IL); Efraim Goldenberg, Tel-Aviv (IL); Eyal Dery, Tel-Aviv (IL)

Correspondence Address: DIGITAL OPTICS CORPORATION, C/O LEE & MORSE, P.C., 3141 FAIRVIEW PARK DRIVE, SUITE 500, FALLS CHURCH, VA, 22042, US

(21) Appl. No.: 12/213,474

(22) Filed: Jun. 19, 2008

Related U.S. Application Data
(63) Continuation of application No. PCT/IB2007/004386, filed on Sep. 14, 2007.
(60) Provisional application No. 60/825,615, filed on Sep. 14, 2006.
(60) Provisional application No. 60/825,658, filed on Sep. 14, 2006.

(51) Int. Cl. G03B 13/00; G02B 27/00; H04N 5/228

(52) U.S. Cl. 348/222.1; 359/724; 348/345; 348/E05.031

(57) ABSTRACT

An imaging system includes an optical system for projecting an object onto a detector, and a phase element between an entrance pupil of the optical system and the detector, the phase element adapted to provide a more uniform modulation transfer function over a range of focus than the optical system alone, wherein an effective focal length of light output from the phase element is a function of an angular component on which the light is incident on the phase element.

### BACKGROUND OF THE INVENTION

1. Field of the Invention

Embodiments are directed to an imaging system, more particularly to an imaging system improving the wavefront of light in an imaging system for controlling focus related aberrations, improving the modulation transfer function (MTF), and associated methods.

2. Description of Related Art

Image capturing devices have become widely used in portable and non-portable devices such as cameras, mobile phones, webcams and notebook computers. These image capturing devices conventionally include an electronic image detector such as a CCD or CMOS sensor, a lens system for projecting an object in a field of view (FOV) onto the detector, and electronic circuitry for receiving and storing electronic data provided by the detector.

Conventional imaging system are very sensitive to defocus, as may be seen from FIG. 10, which illustrates a through-focus modulation transfer function (TF-MTF) plow showing MTF versus focus shift in millimeters for light having a wavelength of 0.5461 microns at a spatial frequency of 100 cycles per millimeter for a conventional lens system. The MTF is the spatial frequency response or modulus of the optical transfer function (OTF). The MTF of a system is a measure of the ability of the system to transfer contrast at a particular resolution level from the object to the image, i.e., MTF represents both resolution and contrast. As the spatial frequency increases at the object, it is more difficult for the lens system to efficiently transfer contrast. As can be seen in FIG. 10, minor shifts on either side of focus lead to a dramatic drop in MTF.

There are, however, applications that need imaging of an object in an extended depth of field (EDOF), even if this means sacrificing contrast and/or resolution. EDOF may be especially of interest for smaller, simpler, cheaper, and lighter optical systems.

One current solution includes a phase element in which rays entering at different locations travel a different optical path. Therefore, these rays possess different phase when exiting from the phase element. When properly selected, the difference in phase is expressed as a change in focal length. The image from the detector may be spatially blurred due to the phase change, but the image has all of the data in the frequency domain, i.e., includes optical information at all spatial frequencies, thus enabling insensitivity to defocus and image restoration. In contrast, as noted above, a conventional system may be very sensitive to defocus and may lack optical information, e.g., have an MTF approaching zero, at certain spatial frequencies due to defocus.

Image processing may then be used to remove the blur from the image, thus removing the phase added by the phase element. This results in a higher depth of field/depth of focus and in high insensitivity to defocused value. Higher MTF demands lower gain in the image processing, thus lowering the noise that is being amplified (“noise gain”) and yielding a better image.

Phase elements typically allocate different section of the phase element to focus light at different positions along the Z axis. Such allocation typically only accounts for distance coordinates, i.e., radial or Cartesian coordinates. An example of a cubic phase element is illustrated in FIG. 12. The surface sag may be represented by Equation 1:

Sag=Amp*(X³+y³) (1)

FIG. 11 illustrates a TF-MTF plot for light having a wavelength of 0.5461 microns at a spatial frequency of 100 cycles per millimeter when the system has the phase element shown in FIG. 12. As can be seen therein, use of a phase element may make the lens system less sensitive to defocus, i.e., the MTF is relatively constant at a given spatial frequency over a given range of defocus.

While FIGS. 10 and 11 illustrate that such phase elements do provide better insensitivity to defocus, FIGS. 10 and 11 also illustrates how much MTF is lost near the in focus region due to the phase element. Thus, phase elements providing even better MTF and smoother continuous depths of field are still needed.

### SUMMARY OF THE PRESENT INVENTION

The present invention is therefore directed to a digital camera and associated methods that substantially overcome one or more of the problems due to the limitations and disadvantages of the related art.

It is a feature of an embodiment of the present invention to provide a imaging system adapted to control phase in order to establish an extended depth of field (EDOF).

It is another feature of an embodiment of provide an EDOF phase element having reduced processing requirements.

At least one of the above and other features and advantages of the present invention may be realized by providing an imaging system, including an optical system for projecting an object onto a detector, and a phase element between an entrance pupil of the optical system and the detector, the phase element adapted to provide a more uniform modulation transfer function over a range of focus than the optical system alone, wherein an effective focal length of light output from the phase element is a function of an angular component on which the light is incident on the phase element.

The function may include a radial component. The angular component and the radial component of the function may be separable. The angular component may be a first order equation and the radial component is a second order equation. The angular component may be sin(θ) or may approximate sin(θ/2).

The angular component may be a first order equation. The phase element is positioned substantially at an aperture stop of the imaging system. The phase element may be between the optical system and the detector. The phase element may be before the optical system.

The imaging system may include an image processor adapted to process data from the detector and to generate an output image. The image processor may be adapted to deconvolve data from the detector. The image processor may be adapted to select a deconvolution kernel from kernels having less than a ten by ten array, e.g., a five by five array. The image processor may be adapted to select a deconvolution kernel from kernels having different rotation angles. The image processor may be adapted to select a deconvolution kernel from normal kernels and macro kernels.

The detector may be an eye or may be a digital detector.

A maximum modulation transfer function may be greater than about 0.3 and less than a maximum modulation transfer function of the optical system alone. The imaging system as claimed in claim 1, wherein the detector is a digital detector.

At least one of the above and other features and advantages of the present invention may be realized by providing a method for imaging light from on object onto a detector, the method including projecting light through an optical system for projecting the light onto the detector, and positioning a phase element between an entrance pupil of the optical system and the detector, the phase element modifying the phase of the light to provide a more uniform modulus transfer function over a range of focus than the optical system alone, wherein an effective focal length of light output from the phase element is a function of an angular component on which the light is incident on the phase element.

The method may include processing data output from the detector and generating an image.

### BRIEF DESCRIPTION OF THE DRAWINGS

The above and other features and advantages of the present invention will become readily apparent to those of skill in the art by describing in detail embodiments thereof with reference to the attached drawings, in which:

FIG. 1 illustrates a schematic representation of a general angularly dependent phase element;

FIGS. 2A and 2B illustrate a phase element in accordance with an embodiment of the present invention;

FIGS. 3A and 3B illustrate a phase element in accordance with an embodiment of the present invention;

FIG. 4 illustrates MTF versus focus shift for the phase element in FIGS. 2A and 2B;

FIG. 5 illustrates MTF versus focus shift for the phase element in FIGS. 3A and 3B;

FIG. 6 illustrates a block diagram of an imaging system in accordance with an embodiment;

FIG. 7 illustrates a flow chart of an operation of an image processor in accordance with an embodiment;

FIG. 8 illustrates an exploded view of a digital camera in accordance with an embodiment;

FIG. 9A illustrates a perspective view of a portable computer with a digital camera integrated therein in accordance with an embodiment;

FIG. 9B illustrates a front and side view of a mobile telephone with a digital camera integrated therein in accordance with an embodiment;

FIG. 10 illustrates MTF versus focus shift for a conventional lens system;

FIG. 11 illustrates MTF versus focus shift for a lens system including a related art phase element; and

FIG. 12 illustrates a related art phase element.

### DETAILED DESCRIPTION OF THE INVENTION

U.S. Provisional Application Nos. 60/825,615 and 60/825,658, both filed on Sep. 14, 2006, entitled: “IMPROVED PERFORMANCE IMAGING APPARATUS” and “EXTENDED DEPTH OF FIELD LENS IN VISION CORRECTION OPTICAL SYSTEMS,” respectively, are hereby incorporated by reference in their entirety.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the figures, the dimensions of layers and regions are exaggerated for clarity of illustration. Like reference numerals refer to like elements throughout.

Previous methods allocate different sections of the lens to focus the light in different places along the Z axis, i.e., the optical axis, dependent only on distance. In contrast, according to embodiments, allocation of lens area may also be made angularly, e.g., primarily angularly. By changing the phase and amplitude as a function of the angle θ and the radial distance R, as indicated by Equation 2:

optical_element=α(θ,R)exp(−iA(θ,R)) (2)

where A(θ,R) describes the angular and radial dependence function of the phase and α(θ,R) describes the angular and radial dependence function of the attenuation. Using specific functions allows changing the focal length for each angular element, thus creating a continuous focal length for all wavelengths.

For simplification, the angular and radial components may be separated as shown in Equation 3 to:

phase_of_element=A(θ)B(R) (3)

when −π≦θ≦π and 0≦R≦Element_Radius

Where A(θ) describes the angular dependence function of the phase amplitude and B(R) describes the radial dependence function. This phase may be radially asymmetric, allowing for a larger EDOF.

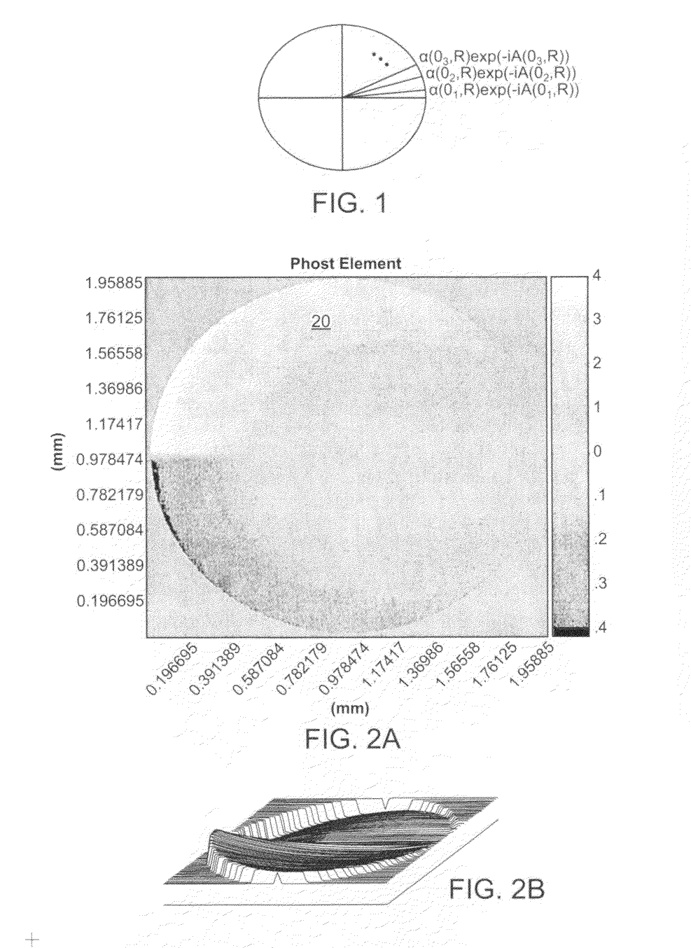

FIG. 1 illustrates the basic angular dependent phase and amplitude element. Note that each angle has different phase amplitude A and the radial dependence may be set as needed. Each angular component may have different phase amplitude, thus enabling continuous focal length change for the optical system.

A specific example is shown in FIGS. 2A and 2B, in which a phase element 20 may have A(θ) approximating sin(θ/2), i.e., forcing the discontinuities to be continuous, and B(R) may equal R². This phase element 20 may produce a different phase amplitude for each angular component and a surface thereof may have a spiral shape, as may be seen from a contour of the surface sag illustrated in FIG. 2B. In addition, using the R² function ensures that all of the light from each angular component has the same focal length change, i.e., be directed to the same spot on the Z axis.

The sag of the spiral surface may be defined as follows, to arrive at Equations 4 and 5:

$$- π \underline{<} θ < π \qquad Δ = \frac{π}{60} \qquad x = \frac{θ}{π}$$

$$\begin{matrix}{F}_{1} = x - \frac{{x}^{11}}{11} \\ {F}_{2} = \{ \begin{matrix}[ 1 - exp ( \frac{θ - π}{Δ} ) ] / [ 1 + exp ( \frac{θ - π}{Δ} ) ] & θ \underline{>} 0 \\ - [ 1 - exp ( \frac{θ + π}{Δ} ) ] / [ 1 + exp ( \frac{θ + π}{Δ} ) ] & θ < 0\end{matrix}\end{matrix}$$

$$\begin{matrix}f = Amp \cdot {F}_{1} \cdot {F}_{2} + focal & ( 4 ) \\ \begin{matrix}Sag = {R}^{2} \frac{( F - focal )}{focal \cdot F} + {Z}_{0} [ mm ] & {Z}_{0} = 0.01 [ mm ]\end{matrix} & ( 5 )\end{matrix}$$

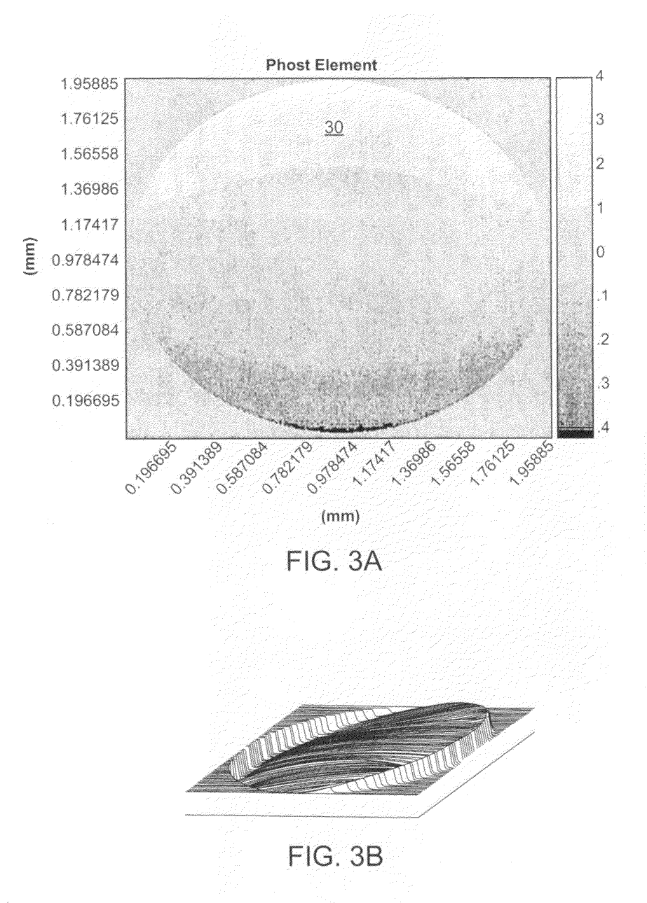

Another example is illustrated in FIGS. 3A and 3B, in which a phase element 30 may have A(θ) being sin(θ) and B(R) being R². This function will provide different focal spot characteristics than the phase element 20 of FIGS. 2A and 2B. This phase element 30 may produce a different phase amplitude for each angular component and a surface thereof may have a wave shape, as may be seen from a contour of the surface sag illustrated in FIG. 3B. In addition, using the R² function ensures that all of the light from each angular component has the same focal length change, i.e., be directed to the same spot on the Z axis.

The wave surface shape of the phase element 30 illustrated in FIGS. 3A and 3B may also be represented by Equation 5, but wherein F is defined by Equation 6:

F=sinθ (6)

Due to the fact that the change is basically continuous along the angular axis (θ), the focal length also changes continuously. Moreover, this specific A(θ) function allows uniform spread of the optical power along the continuously changed focal length, hence yielding a smoother MTF that is closer to the diffraction limited MTF. Further, a phase element in accordance with embodiments may provide an equal angle between every ray and the Z axis, since the entire radius of the element may be used. This may allow uniform focal point characteristics for all the components. Further, while the above embodiments have used R² to optimize power of the radial term, this power may be any power term depending on the system in which the phase element is to be used or may even remain constant.

Thus, in accordance with embodiment using this general set of functions A(θ) B(R) or A(θ, R) a diverse set of angularly dependent phase elements may be realized in order to obtain different focal length qualities and efficiencies.

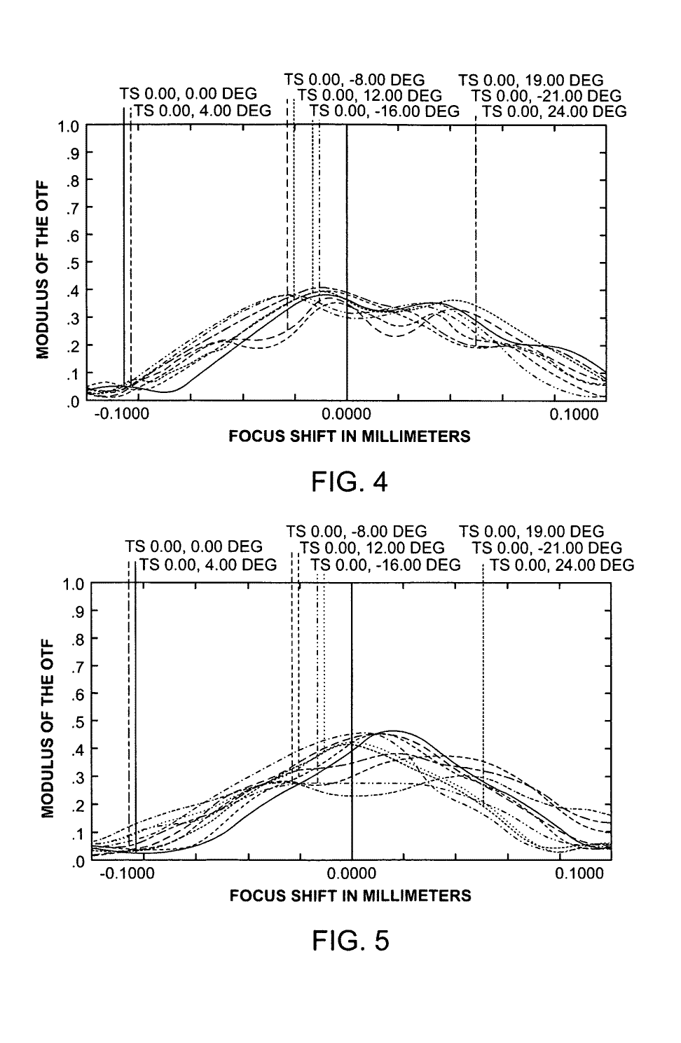

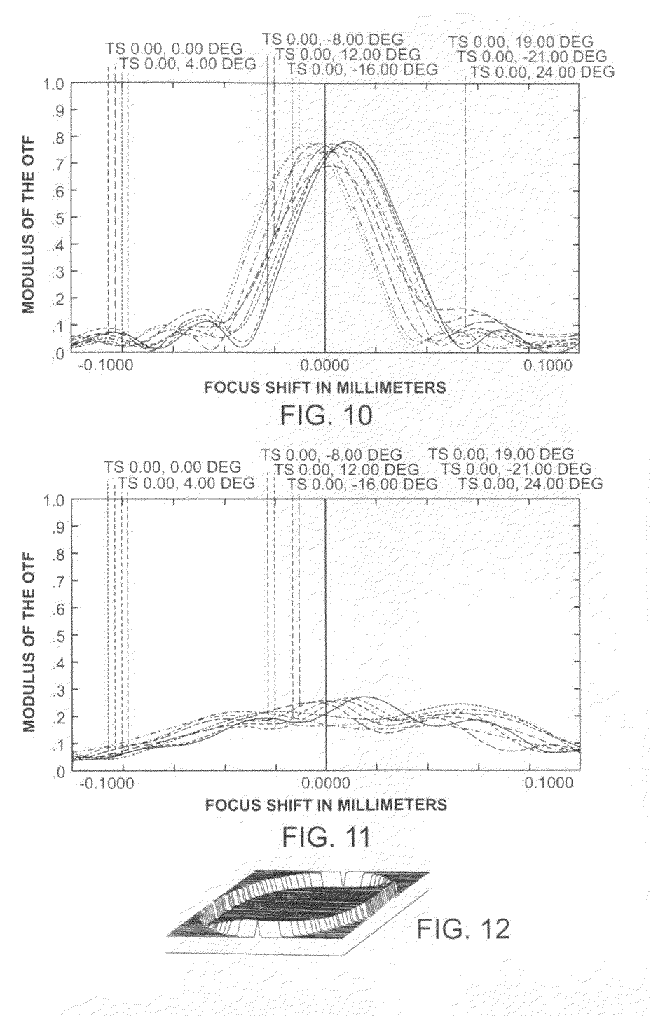

FIGS. 4 and 5 respectively illustrate MTF versus focus shift in millimeters for light having a wavelength of 0.5461 microns at a spatial frequency of 100 cycles per millimeter when the system includes the spiral surface shape phase element 20 and the wave surface shape phase element 30. As can be seen from comparing FIGS. 4 and 5 to FIG. 11, the cubic phase element used to generate FIG. 11 otherwise having the same parameters as the phase elements use to generate FIGS. 4 and 5, the phase element in accordance with embodiments may provide a higher MTF than previous phase elements. For example, as can be seen in FIG. 11, the MTF peak is less than 0.3, while in FIGS. 4 and 5, the MTF peak is greater than 0.3.

As may be seen from FIGS. 2A and 3A, in the particular examples illustrated, the phase element 20, 30 may be about 2 mm by 2 mm along the X and Y axis, and may vary by about eight microns, i.e., +4 microns, along the Z axis. The phase element 20, 30 may have a radius of about 3.7 mm. The phase element 20, 30 may be made of any appropriate material, e.g., glass or plastic, and may be made in accordance with any appropriate processes, e.g., molding or replicating.

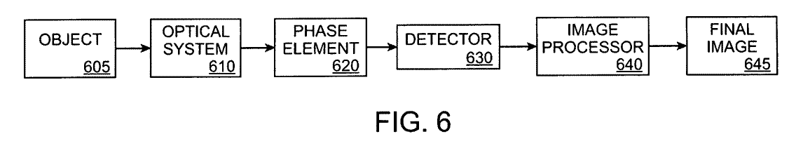

FIG. 6 illustrates a block diagram of an imaging system 600 including an angularly dependent phase element in accordance with embodiments. As shown therein, the imaging system 600 may include an optical system 610 to image an object 605, an angularly dependent phase element 620, a detector 630, and an image processor 640 that outputs a final image 645. The image processor 640 may process the detected image in a manner that restores the image resolution. The image processor 640 may incorporate various techniques that include, for example, filtering, edge detection, and morphological operations.

The phase element 620 may be placed at an aperture stop of the system. While the phase element 620 is shown as being between the optical system 610 and the detector 630, the phase element may be placed on a surface within the optical system 610, i.e., may be between an entrance pupil of the optical system 610 and the detector 630, or may be in front of the optical system 610. A surface of the phase element 620 having a varying sag thereon may be on a front surface facing the object 605 or on a rear surface facing the detector 630. The phase element 620 may be placed on a surface within the optical system 610 that is nearest an aperture stop of the system.

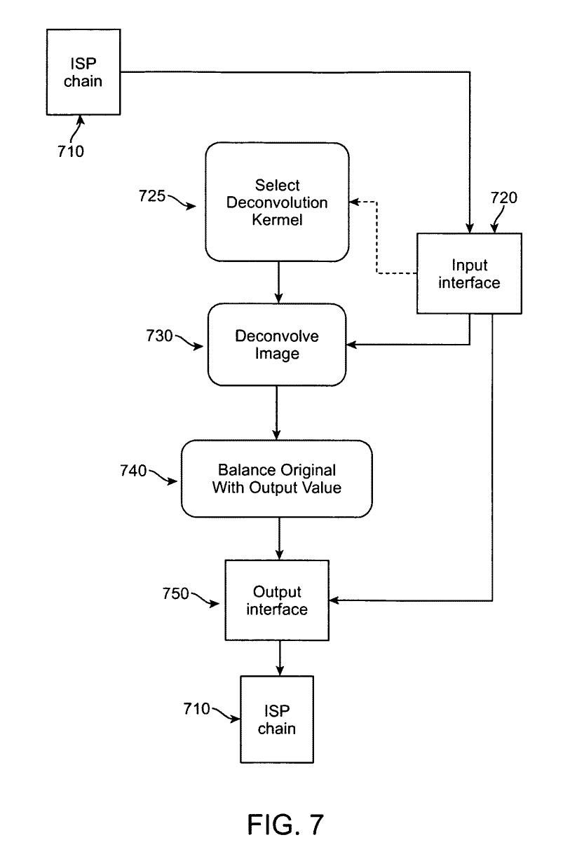

FIG. 7 illustrates a flow chart for a portion of operation of the image processor 640.

As can be seen therein, the image processor 640 may include an image signal processing (ISP) chain 710 that receives an image from the detector 630. This image may be, for example, raw Bayer data or a bitmap image. The image may be supplied to the operation 730 via an input interface 720. Operation 730 may also receive deconvolution kernels selected from a kernels bank in operation 725. Operation 730 may use any suitable deconvolution method, and may output the resultant pixel values to an output interface 750. If needed in accordance with a desired end use, image quality of the output image may be improved in operation 740 by balancing the original pixel value with the output pixel value. For example, the input interface 720 may supply parameters, e.g., a signal to noise estimation, information regarding the pixel environment and spatial location information, to operation 740 to accordingly adjust the output pixel value. The output image may be returned to the ISP chain 710, where further processing may be performed on the image, e.g., denoising or compression, such as JPEG compression or GIF compression.

The dashed connector between the input interface 720 and operation 725 may be provided if the image capturing device is to operate in more than one image capture mode, e.g., a normal mode and a macro mode. If so, different kernel banks will be needed for each mode, so the input interface 720 will need to provide the image capture mode information to operation 725. Additionally or alternatively, due to the angular dependency of the phase element in accordance with embodiments, the kernel bank may include kernels with different rotation angles. Therefore, the input interface 720 may provide an estimated rotation angle of the PSF to operation 725.

In accordance with embodiment, when the function is of lower order, e.g., first order for the angular component and second order for the radial component, and/or is separable into radial and angular functions, computation thereof may be relatively simple. For example, when the spiral surface phase element 20 is used, the deconvolution may require only a 5×5 kernel, as opposed to the 11×11 required for the cubic phase element illustrated in FIG. 12.

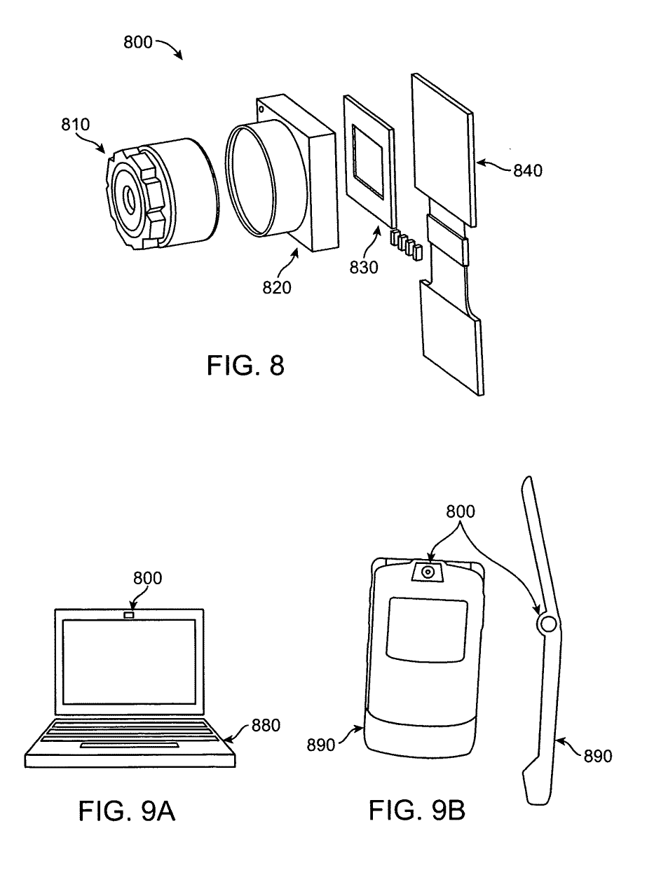

FIG. 8 illustrates an exploded view of a digital camera 800 in which a phase element in accordance with embodiments may be employed. As seen therein, the digital camera 800 may include a stack of lenses 810 to be secured to a lens holder 820, which, in turn, may be secured to a sensor 830. The phase element 620 according to an embodiment may be placed at the aperture stop of the digital camera. Finally, the entire assembly may be secured to electronics 840.

FIG. 9A illustrates a perspective view of a computer 880 having the digital camera 800 integrated therein. FIG. 9B illustrates a front and side view of a mobile telephone 890 having the digital camera 800 integrated therein. Of course, the digital camera 800 may be integrated at other locations than those shown.

The above EDOF phase elements may be created using any suitable material, e.g., polycarbonates, such as E48R produced by Zeon Chemical Company, acrylic, PMMA, etc., or glasses, may be used. Additionally, each lens may be made of different materials in accordance with a desired performance thereof. The lenses may be made in accordance with any appropriate method for the selected material, e.g., injection molding, glass molding, replication, wafer level manufacturing, etc.

In addition to the uses noted above in imaging systems including image processors, EDOF phase elements in accordance with embodiments may be used in the field of human vision, e.g., glasses, contact lenses, cataract lenses, telescopes, microscopes, binoculars, etc. For such use, the retina would serve as the detector 630 and the brain would serve as the image processor 640. While the eye's lens has a variable focal length, allowing focusing on different objects at different distances, viewing correction or special viewing abilities may be desired. For example, during cataract surgery, standard procedure is to replace the eye lens with a fixed focus lens. However, by using an EDOF lens, e.g., as disclosed in accordance with embodiments, allows the eye to maintain a variable focal length, reducing or eliminating dependence on external viewing aids. For special viewing instruments, incorporation of such an EDOF lens may reduce or eliminate the need for manual adjustment.

As described herein, when a layer or element is referred to as being “on” another layer or substrate, it can be directly on the other layer or substrate, or intervening layers may also be present. When a layer is referred to as being “under” another layer, it can be directly under, and one or more intervening layers may also be present. When a layer is referred to as being “between” two layers, it can be the only layer between the two layers, or one or more intervening layers may also be present. When an element or layer is referred to as being “connected” or “coupled” to another element or layer, it can be directly connected or coupled to the other element or layer, or intervening elements or layers may be present. In contrast, when an element is referred to as being “directly connected” or “directly coupled” to another element or layer, no intervening elements or layers are present.

As used herein, the term “and/or” includes any and all combinations of one or more of the associated listed items. Further, although terms such as “first,” “second,” “third,” etc., may be used herein to describe various elements, components, regions, layers and/or sections, these elements, components, regions, layers and/or sections should not be limited by these terms. These terms are only used to distinguish one element, component, region, layer and/or section from another. Thus, a first element, component, region, layer and/or section could be termed a second element, component, region, layer and/or section without departing from the teachings of the embodiments described herein.

Spatially relative terms, such as “beneath,” “below,” “lower,” “above,” “upper,” etc., may be used herein for ease of description to describe the relationship of one element or feature to another element(s) or feature(s), as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

As used herein, the singular forms “a,” “an” and “the” are intended to include the plural forms as well, unless the context clearly indicates otherwise. It will be further understood that the terms “comprises,” “comprising,” “includes,” and “including” specify the presence of stated features, integers, steps, operations, elements, components, etc., but do not preclude the presence or addition thereto of one or more other features, integers, steps, operations, elements, components, groups, etc.

Embodiments of the present invention have been disclosed herein and, although specific terms are employed, they are used and are to be interpreted in a generic and descriptive sense only and not for purpose of limitation. While embodiments of the present invention have been described relative to a hardware implementation, the processing of present invention may be implemented in software, e.g., by an article of manufacture having a machine-accessible medium including data that, when accessed by a machine, cause the machine to deconvolve the data. Accordingly, it will be understood by those of ordinary skill in the art that various changes in form and details may be made without departing from the spirit and scope of the present invention as set forth in the following claims.

What is claimed is:

1. An imaging system, comprising:
an optical system for projecting an object onto a detector; and
a phase element between an entrance pupil of the optical system and the detector, the phase element adapted to provide a more uniform modulation transfer function over a range of focus than the optical system alone, wherein an effective focal length of light output from the phase element is a function of an angular component on which the light is incident on the phase element.

2. The imaging system as claimed in claim 1, wherein the function includes a radial component.

3. The imaging system as claimed in claim 2, wherein the angular component and the radial component of the function are separable.

4. The imaging system as claimed in claim 3, wherein the angular component is a first order equation and the radial component is a second order equation.

5. The imaging system as claimed in claim 4, wherein the angular component is sin(θ).

6. The imaging system as claimed in claim 4, wherein the angular component approximates sin(θ/2).

7. The imaging system as claimed in claim 1, wherein the angular component is a first order equation.

8. The imaging system as claimed in claim 1, wherein the phase element is positioned substantially at an aperture stop of the imaging system.

9. The imaging system as claimed in claim 1, further comprising an image processor adapted to process data from the detector and to generate an output image.

10. The imaging system as claimed in claim 9, wherein the image processor is adapted to deconvolve data from the detector.

11. The imaging system as claimed in claim 10, wherein the image processor is adapted to select a deconvolution kernel from kernels having less than a ten by ten array.

12. The imaging system as claimed in claim 11, wherein the image processor is adapted to select a deconvolution kernel from kernels having a five by five array.

13. The imaging system as claimed in claim 10, wherein the image processor is adapted to select a deconvolution kernel from kernels having different rotation angles.

14. The imaging system as claimed in claim 10, wherein the image processor is adapted to select a deconvolution kernel from normal kernels and macro kernels.

15. The imaging system as claimed in claim 1, wherein the detector is an eye.

16. The imaging system as claimed in claim 1, wherein a maximum modulation transfer function is greater than about 0.3 and less than a maximum modulation transfer function of the optical system alone.

17. The imaging system as claimed in claim 1, wherein the detector is a digital detector.

18. The imaging system as claimed in claim 1, wherein the phase element is between the optical system and the detector.

19. The imaging system as claimed in claim 1, wherein the phase element is before the optical system.

20. A method for imaging light from on object onto a detector, the method comprising:
projecting light through an optical system for projecting the light onto the detector; and
positioning a phase element between an entrance pupil of the optical system and the detector, the phase element modifying the phase of the light to provide a more uniform modulus transfer function over a range of focus than the optical system alone, wherein an effective focal length of light output from the phase element is a function of an angular component on which the light is incident on the phase element.

21. The method as claimed in claim 20, further comprising:
processing data output from the detector; and
generating an image.
